(19) United States
(12) Patent Application Publication
(10) Pub. No.: US 2008/0111284 A1
(43) Pub. Date: May 15, 2008

(54) Method of manufacturing a molding structure, and method and apparatus for molding a substrate using the molding structure

(75) Inventors: Cheol-Joon Yoo, Gyeonggi-do (KR); Tae-Sung Yoon, Chungcheongnam-do (KR)

Correspondence Address: MILLS & ONELLO LLP, ELEVEN BEACON STREET, SUITE 605, BOSTON, MA, 02108, US

(73) Assignee: Samsung Electronics Co., Ltd., Suwon-si (KR)

(21) Appl. No.: 11/985,146

(22) Filed: Nov. 14, 2007

(30) Foreign Application Priority Data
Nov. 15, 2006 (KR) 10-2006-0112577

(51) Int. Cl. B29C 43/18

(52) U.S. Cl. 264/447; 264/101; 425/405.1

(57) ABSTRACT

In a method of molding a substrate, a molding structure including a release film and flat plate-shaped epoxy molding compound (EMC) is placed on an upper face of a lower die. The substrate is held by a lower face of an upper die facing the lower die. The molding structure and the substrate are compressed using the lower die and the upper die to form a preliminarily molded substrate. The lower die is then downwardly moved from the upper die to form a molded substrate.

### CROSS-REFERENCE TO RELATED APPLICATIONS

This application claims priority under 35 USC § 119 to Korean Patent Application No. 10-2006-0112577 filed on Nov. 15, 2006 in the Korean Intellectual Property Office (KIPO), the contents of which are herein incorporated by reference in their entirety.

### BACKGROUND OF THE INVENTION

1. Field of the Invention

Example embodiments of the present invention relate to a method of manufacturing a molding structure, and a method and an apparatus for molding a substrate using the molding structure. More particularly, example embodiments of the present invention relate to a method of manufacturing a molding structure that has a flat plate shape formed from epoxy molding compound (EMC) powder, and a method and an apparatus for molding a substrate using the molding structure.

2. Description of the Related Art

Generally, epoxy molding compound (EMC) including a plastic material encapsulates a semiconductor chip to protect semiconductor circuits in the semiconductor chip from external environmental effects and contaminants. The EMC may significantly affect productivity and reliability of a semiconductor device. Thus, a process for molding the semiconductor chip using the EMC is given a great deal of weight in semiconductor fabrication processes.

According to a conventional method, the semiconductor chip is molded by covering the semiconductor chip with EMC powder, and by compressing the EMC powder. Specifically, the EMC powder is received in a cavity of a lower die. When the lower die is upwardly moved, a compression spring compresses the EMC powder. Melted EMC in the cavity is molded into a plate having a uniform thickness to form a substrate attached to an upper die.

However, the conventional compression molding method using the EMC powder may have the following problems.

To mold the substrate at a uniform thickness, weight measurement of the EMC powder may be required. Thus, since a weight-measuring unit for measuring the weight of the EMC powder may be needed, the molding apparatus may have a large size. Further, a time for measuring the weight of the EMC powder may be additionally required. As a result, time of the molding process may be lengthened so that productivity of the molding process may be reduced.

Further, to mold the substrate at a uniform thickness, the EMC powder may be uniformly spread in the cavity. Thus, since a spreading unit for uniformly spreading the EMC powder may be required, the molding apparatus may have a large size. Further, a time for uniformly spreading the EMC powder may be additionally required. As a result, a time of the molding process may be further lengthened so that productivity of the molding process may be further reduced.

Furthermore, the molding dust generated from the EMC powder may pollute the molding apparatus so that the molding apparatus may frequently malfunction.

### SUMMARY OF THE INVENTION

Example embodiments of the present invention provide a method of manufacturing a molding structure that is used for a process for molding a substrate using epoxy molding compound (EMC) powder.

Example embodiments of the present invention also provide a method of molding a substrate using the above-mentioned molding structure.

Example embodiments of the present invention also provide an apparatus for performing the above-mentioned molding method.

According to one aspect, the present invention is directed to a method of manufacturing a molding structure. According to the method, a first release film is attached on an upper face of a lower die. EMC powder is applied to the first release film. A second release film is attached on a lower face of an upper die facing the upper face of the lower die. The EMC powder is compressed using the upper die and the lower die to form a flat plate-shaped EMC. The upper die and the lower die are separated from each other with the first release film being attached to the flat plate-shaped EMC to form a molding structure including the flat plate-shaped EMC and the first release film.

According to an example embodiment, attaching the first release film, applying the EMC powder, attaching the second release film, forming the flat plate-shaped EMC and forming the molding structure may be carried out at room temperature.

According to an example embodiment, the second release film may be attached to the upper die using vacuum.

According to an example embodiment, the first release film may have a thickness greater than that of the second release film.

According to an example embodiment, the second release film may be repeatedly used.

According to an example embodiment, an adhesive may be formed on an upper face of the first release film that makes contact with the EMC powder.

According to another aspect, the invention is directed to a method of molding a substrate. According to the method, a molding structure including a release film and a flat plate-shaped EMC is placed on an upper face of a lower die. A substrate is held by a lower face of an upper die facing the lower die. The molding structure and the substrate are compressed using the lower die and the upper die to form a preliminarily molded substrate. The release film is removed from the preliminarily molded substrate to form a molded substrate.

According to an example embodiment, the molding structure on the lower die is heated. According to an example embodiment, the molding structure on the lower die may be heated to a temperature of about 150° C. to about 180° C.

According to an example embodiment, ultraviolet rays may be irradiated to the release film to remove the release film from the preliminarily molded substrate.

According to an example embodiment, the substrate may be held by the upper die using vacuum.

According to an example embodiment, the substrate may include a printed circuit board (PCB) having chips or a semiconductor substrate having solder balls.

According to another aspect, the present invention is directed to an apparatus for molding a substrate. The apparatus of the invention includes a lower die, an upper die, a drive unit, a storage unit and a transfer arm. The lower die holds a molding structure for molding the substrate. The upper die is arranged facing the lower die to hold the substrate. The drive unit upwardly and downwardly moves the lower die. The storage unit stores a plurality of the molding structures. The transfer arm transfers the molding structure in the storage unit to the lower die.

The transfer arm can heat the molding structure.

According to an example embodiment, the upper die may have a vacuum hole vertically formed through the upper die through which vacuum for holding the substrate is supplied.

According to an example embodiment, the storage unit may have a space for receiving the molding structures. Further, the storage unit may include a case having an open upper face, and a rotary plate vertically passing through a bottom face of the case. The case may have a passageway through which air circulates. The rotary plate may support the stacked molding structures. Further, the rotary plate may be rotated to upwardly move the molding structures through the open upper face of the case.

According to still an example embodiment, the transfer arm may have a vacuum hole through which vacuum for holding the molding structure is supplied. Further, a heater for heating the molding structure on the lower die may be built into the transfer arm.

According to the present invention, a molding structure, which is used for molding a substrate, may be formed before performing a molding process. Thus, since EMC powder may not be used in the molding process, a process for measuring a weight of the EMC powder and a process for uniformly spreading the EMC powder may not be required. As a result, a time for the molding process may be shortened so that productivity of the molding process may be improved. Further, a molding apparatus may not be contaminated or malfunction due to dust generated from the EMC powder.

### BRIEF DESCRIPTION OF THE DRAWINGS

The foregoing and other objects, features and advantages of the invention will be apparent from the more particular description of preferred aspects of the invention, as illustrated in the accompanying drawings in which like reference characters refer to the same parts throughout the different views. The drawings are not necessarily to scale, emphasis instead being placed upon illustrating the principles of the invention. In the drawings, the thickness of layers and regions are exaggerated for clarity.

FIG. 1 is a cross-sectional view illustrating an apparatus for forming a molding structure in accordance with an example embodiment of the present invention.

FIG. 2 is a flow chart illustrating a method of manufacturing the molding structure using the molding apparatus in FIG. 1.

FIGS. 3 to 5 are cross-sectional views illustrating the method in FIG. 2.

FIG. 6 is a cross-sectional view illustrating an apparatus for molding a substrate using the method in FIG. 2.

FIG. 7 is a bottom view illustrating a transfer arm in FIG. 6.

FIG. 8 is a flow chart illustrating a method of molding the substrate using the method in FIG. 6.

FIGS. 9 to 12 are cross-sectional views illustrating the method in FIG. 8.

### DESCRIPTION OF THE EMBODIMENTS

The present invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

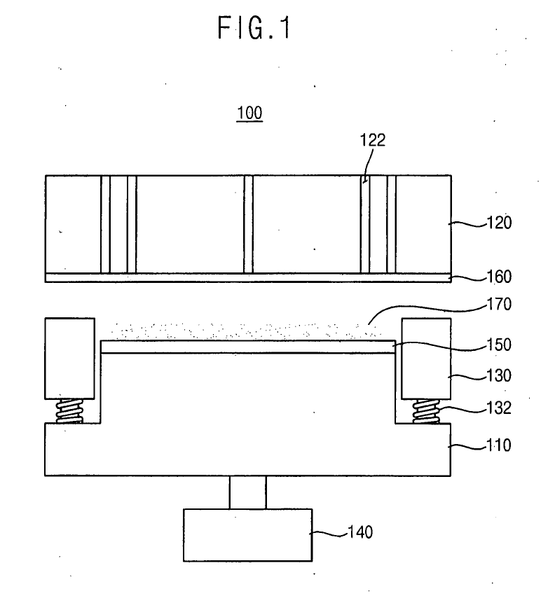

FIG. 1 is a cross-sectional view illustrating an apparatus for forming a molding structure in accordance with an example embodiment of the present invention.

Referring to FIG. 1, an apparatus 100 for forming a molding structure in accordance with this example embodiment includes a lower die 110, an upper die 120, a support member 130, a spring 132 and a drive unit 140.

A first release film 150 and epoxy molding compound (EMC) powder 170 are provided to an upper face of the lower die 110.

The drive unit 140 is connected to the lower die 110. The drive unit 140 upwardly moves the lower die 110 toward the upper die 120 or downwardly moves the lower die 110 from the upper die 120.

The upper die 120 is positioned over the lower die 110. The upper die 120 has vacuum holes 122 vertically formed through the upper die 120. Vacuum is supplied through the vacuum holes 122. The upper die 120 holds a second release film 160 using the vacuum.

The support member 130 is arranged on an edge of the lower die 110. The support member 130 is connected to the lower die 110 through the spring 132. When the lower die 110 is upwardly moved to make contact with the upper die 120, the spring 132 is gradually compressed so that the support member 130 is slowly moved downwardly. Thus, the support member 130 and the spring 132 may reduce impacts generated when the lower die 110 makes contact with the upper die 120.

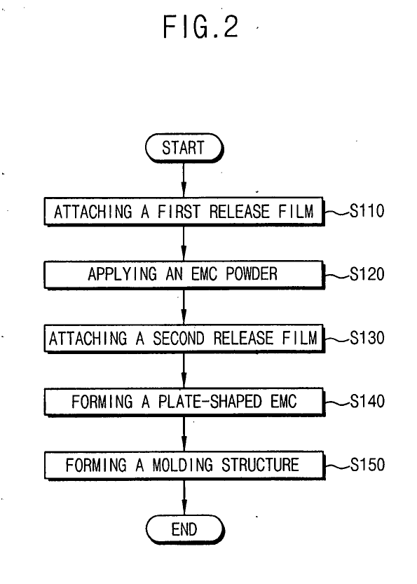

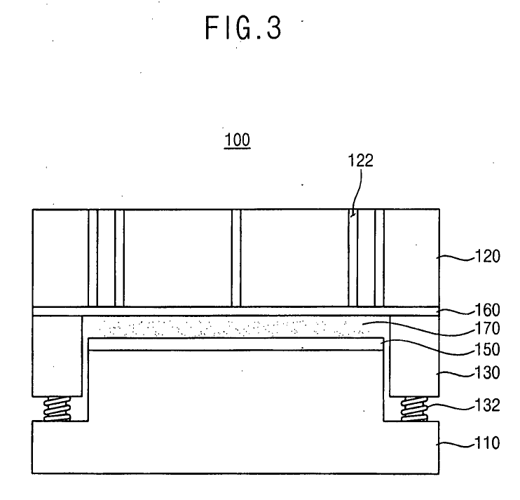

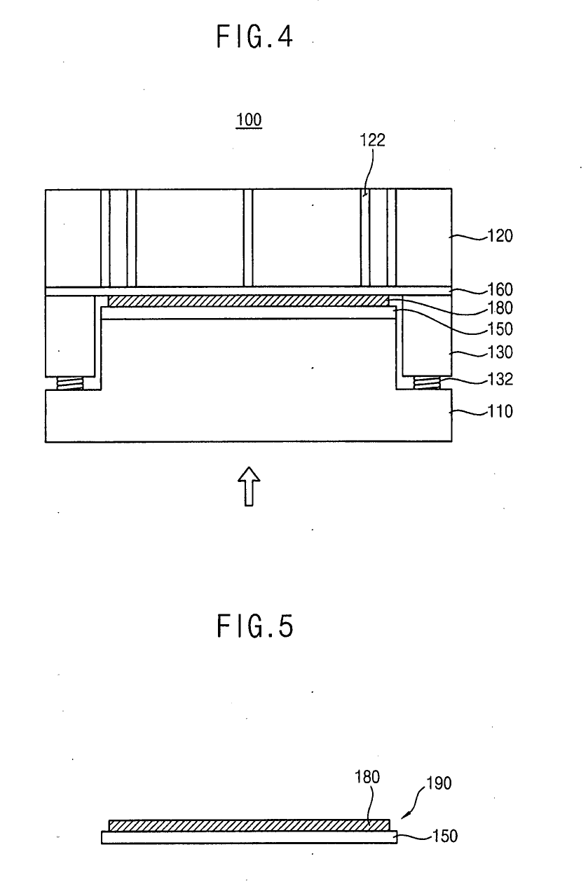

FIG. 2 is a flow chart illustrating a method of manufacturing the molding structure using the molding apparatus in FIG. 1, and FIGS. 3 to 5 are cross-sectional views illustrating the method in FIG. 2.

Referring to FIGS. 1 to 3, in step S110, the first release film 150 is attached on the upper face of the lower die 110. In this example embodiment, the first release film 150 may have a first thickness. The first thickness may be about tens of micrometers to about hundreds of micrometers. For example, to combine the first release film 150 with a flat plate-shaped EMC 180 illustrated later, an adhesive (not shown) may be formed on an upper face of the first release film 150. Alternatively, the first release film 150 may include a material for allowing the first release film to separate from the lower die 110 and the first release film 150 to combine with the flat plate-shaped EMC 180.

In step S120, the EMC powder 170 is applied to the upper face of the first release film 150. In this example embodiment, the EMC 170 may include epoxy resin, phenol resin, silica, various additives, etc. The EMC 170 may be spread on the first release film 150 at a uniform thickness.

In step S130, the second release film 160 is attached to a lower face of the upper die 120. In this example embodiment, the second release film 160 may have a second thickness less than the first thickness. Thus, the second thickness may be tens of micrometers. Further, the second release film 160 may be held by the upper die 120 using vacuum. The vacuum for holding the second release film 160 may be supplied through the vacuum holes 122 vertically formed through the upper die 120. Here, when damage or deformations are not generated at the second release film 160 during a process for forming a molding structure, the second release film 160 may be repeatedly used.

Referring to FIGS. 1, 2 and 4, in step S140, the lower die 110 is upwardly moved toward the upper die 120. As the lower die 110 is upwardly moved, the support member 130 on the edge of the lower die 110 continuously makes contact with the lower face of the upper die 120 so that the spring 132 is continuously compressed. Thus, the support member 130 and the spring 132 may reduce impacts generated when the lower die 110 makes contact with the upper die 120. As the lower die 110 is also upwardly moved, the EMC powder 170 is compressed by the lower die 110 and the upper die 120. The pressure applied to the EMC powder 170 converts the EMC powder 170 into the flat plate-shaped EMC 180.

Referring to FIGS. 1, 2 and 5, in step S150, after forming the flat plate-shaped EMC 180, the lower die 110 is downwardly moved from the upper die 120. Here, the flat plate-shaped EMC 180 may be readily separated from the upper die 120 due to the second release film 160 on the lower face of the upper die 120. Further, the flat plate-shaped EMC 180 may be readily separated from the lower die 110 due to the first release film 150 on the upper face of the lower die 110. In contrast, the first release film 150 may still remain on a lower face of the flat plate-shaped EMC 180 due to the adhesive on the first release film 150. As a result, a molding structure 190 including the flat plate-shaped EMC 180 and the first release film 150 is completed.

Here, since the thick first release film 150 may support the flat plate-shaped EMC 180, the flat plate-shaped EMC 180 may not be readily deformed or damaged.

In this example embodiment, the process for forming the molding structure 190 may be carried out at room temperature. Particularly, attaching the first release film 150 on the lower die 110, applying the EMC powder 170 to the lower die 110, attaching the second release film 160 to the upper die 120, forming the flat plate-shaped EMC 180 and forming the molding structure 190 may be carried out at room temperature. Therefore, the process for manufacturing the molding structure 190 may not require an additional heating process so that the process may become more simple and rapid. Furthermore, the molding structures 190 used for molding a substrate may be manufactured in large quantities by the process for forming the molding structure 190.

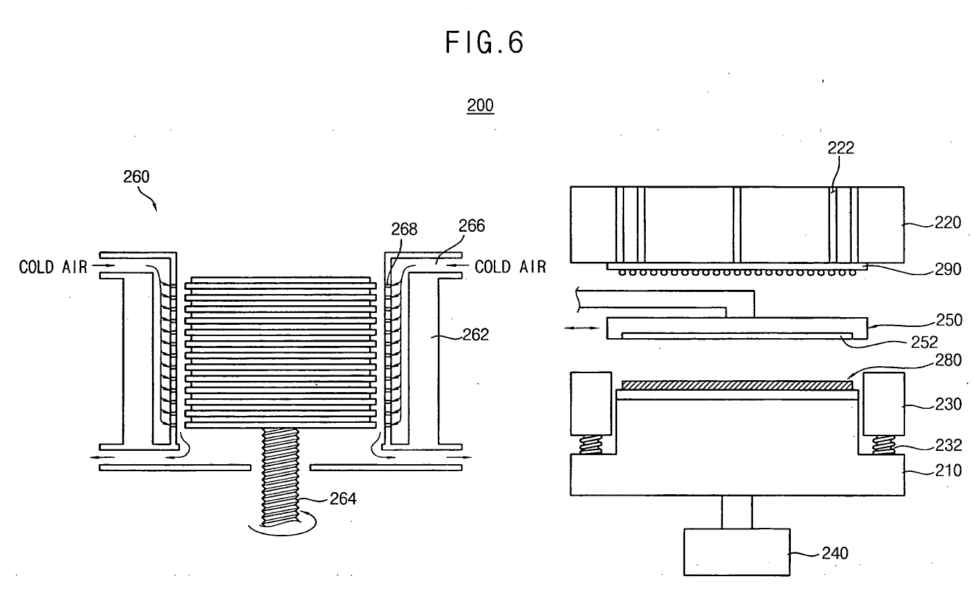

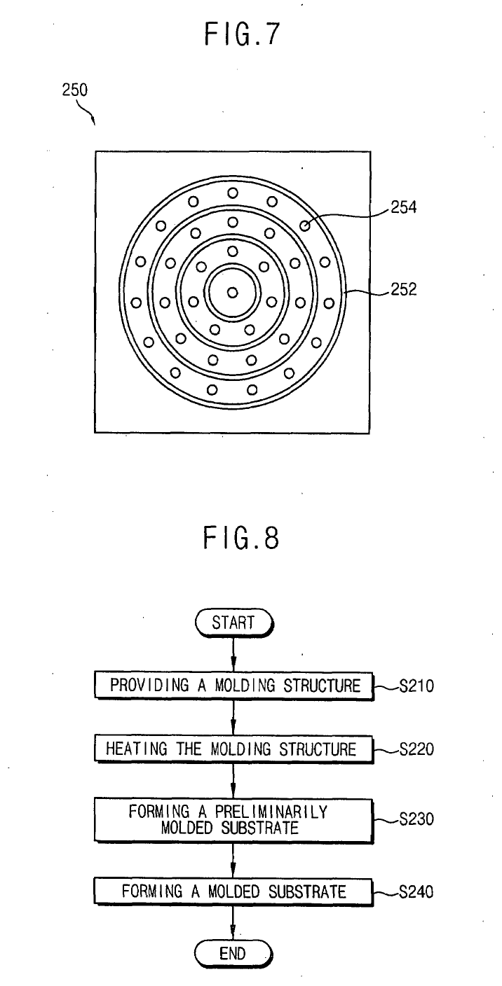

FIG. 6 is a cross-sectional view illustrating an apparatus for molding a substrate using the method in FIG. 2, and FIG. 7 is a bottom view illustrating a transfer arm in FIG. 6.

Referring to FIGS. 6 and 7, an apparatus for molding a substrate in accordance with this example embodiment includes a lower die 210, an upper die 220, a support member 230, a spring 232, a drive unit 240, a transfer arm 250 and a storage unit 260.

A molding structure for molding a substrate 290 is placed on an upper face of the lower die 210.

A first release film 150 and EMC powder 170 are provided to an upper face of the lower die 110.

The drive unit 240 is connected to the lower die 210. The drive unit 240 upwardly moves the lower die 210 toward the upper die 220 or downwardly moves the lower die 210 from the upper die 220.

The upper die 220 is positioned over the lower die 210. The upper die 220 has first vacuum holes 222 vertically formed through the upper die 220. Vacuum is supplied through the vacuum holes 222. The upper die 220 holds the substrate 290 using the vacuum.

The support member 230 is arranged on an edge of the lower die 210. The support member 230 is connected to the lower die 210 through the spring 232. When the lower die 210 is upwardly moved to make contact with the upper die 220, the spring 232 is gradually compressed so that the support member 230 is slowly moved downwardly. Thus, the support member 230 and the spring 232 may reduce impacts generated when the lower die 210 makes contact with the upper die 220.

The transfer arm 250 has second vacuum holes 254. The second vacuum holes 254 are vertically formed through the transfer arm 250 to introduce vacuum into a bottom face of the transfer arm 250. The transfer arm 250 holds the molding structure 280 using the vacuum and then transfers the molding structure 280 to the lower die 210. A heater 252 is built into the transfer arm 250. The heater 252 heats the molding structure 280 transferred to the upper face of the lower die 210. Thus, when the molding structure 280 is held by the transfer arm 250 using the vacuum and then transferred to the upper face of the lower die 210, the heater 252 heats the molding structure 280 on the upper face of the lower die 210.

The storage unit 260 safely stores the molding structures 280 without causing physical property changes to the molding structures 280. The storage unit 260 includes a case 262 and a rotary plate 264.

The case 262 has a hollow space having an open upper face. Further, the case 262 has a passageway 266 through which air circulates. In this example embodiment, the passageway 266 may be formed at a sidewall of the case 262. A plurality of openings 268 for connecting the passageway 266 to the hollow space of the case 262 is formed through the sidewall of the case 262. For example, cold air may flow into the passageway 266. The cold air may be introduced into the hollow space of the case 262 through the openings 268. After the cold air cools the molding structures 280, the cold air may flow into the passageway 266 through openings 268. The cold air may then be exhausted toward the outside of the case 262. Thus, the passageway 266 and the openings 268 may prevent the physical properties of the molding structures 280 from being changed due to heat.

The rotary plate 264 is arranged as passing through a bottom face of the case 262. The rotary plate 264 supports the stacked molding structures 280. The rotary plate 264 is rotated to upwardly move the molding structures 280 through the open upper face of the case 262. Therefore, the transfer arm 250 may readily hold and transfer the molding structure 280.

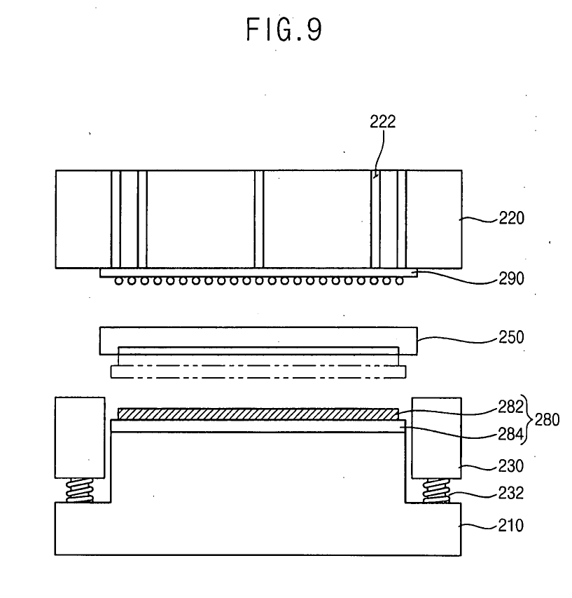

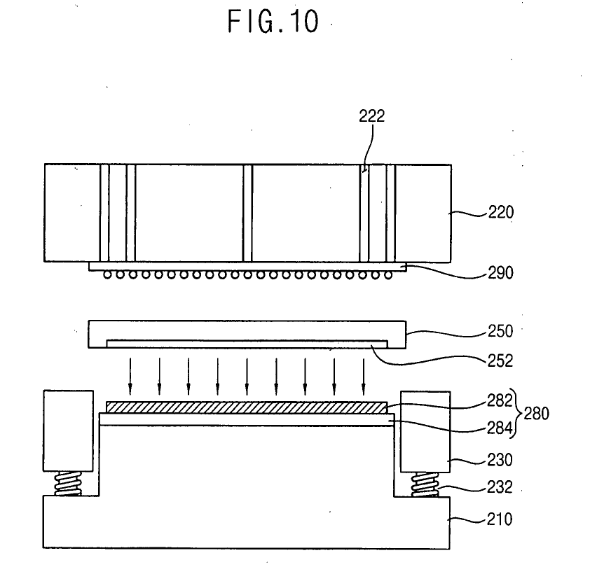

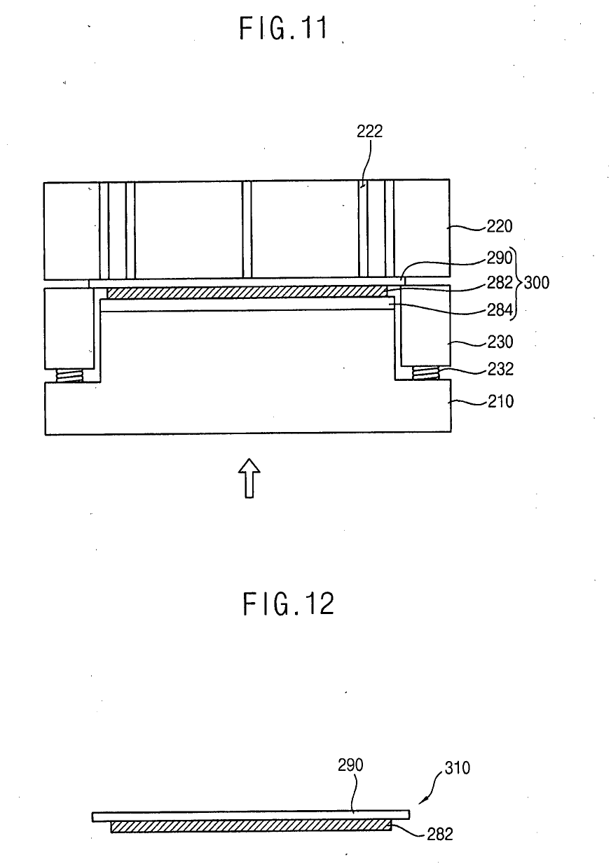

FIG. 8 is a flow chart illustrating a method of molding the substrate using the method in FIG. 6; and FIGS. 9 to 12 are cross-sectional views illustrating the method in FIG. 8.

Referring to FIGS. 6 to 9, in step S210, the transfer arm 250 transfers the molding structure 280 in the storage unit in which a plurality of the molding structures 280 are stacked on the lower die 210. The molding structure 280 is held by the upper face of the lower die 210.

In this example embodiment, the molding structure 280 may include a release film 284 and a flat plate-shaped EMC 282 sequentially stacked. Particularly, the molding structure 280 may be arranged to place the release film 284 on the flat plate-shaped EMC 282. Here, since the molding structure 280 includes the release film 284, an additional release film between the lower die 210 and the molding structure 280 may not be required during the molding process. Thus, a process for attaching a release film to the lower die 210 may be unnecessary.

Referring to FIGS. 6, 8 and 10, in step S220, the transfer arm 250, which completes the transfer of the molding structure 280, is positioned over the lower die 210. The heater 252 in the transfer arm 250 heats the molding structure 280 on the lower die 210.

In this example embodiment, the heater 252 may heat the flat plate-shaped EMC 282 of the molding structure 280. Particularly, the heater 252 may heat the flat plate-shaped EMC 282 to a temperature of about 150° C. to about 180° C. Here, when the flat plate-shaped EMC 282 is heated to a temperature of below about 150° C., the flat plate-shaped EMC 282 may not be sufficiently heated. As a result, the substrate 260 may not be molded with the flat plate-shaped EMC 282. In contrast, when the flat plate-shaped EMC 282 is heated to a temperature of above about 180° C., the flat plate-shaped EMC 282 may be excessively heated. The excessively heated flat plate-shaped EMC 282 may flow along the lower die 210. As a result, the substrate 260 may not also be molded with the flat plate-shaped EMC 282.

Referring to FIGS. 6, 8 and 11, in step S230, the transfer arm 250 is upwardly moved through the upper face of the storage unit 260. Further, the lower die 210 is upwardly moved toward the upper die 220. Here, the substrate 290 is held by the lower face of the upper die 220. In this example embodiment, the substrate 290 may include a semiconductor substrate or a PCB having chips or a semiconductor substrate having solder balls. The substrate 290 may be held by the upper die 220 using the vacuum. The vacuum for holding the substrate 290 may be supplied through the first vacuum holes 222 vertically formed through the upper die 220.

As the lower die 210 is upwardly moved, the support member 230 on the edge of the lower die 210 continuously makes contact with the lower face of the upper die 220 so that the spring 232 is continuously compressed. Thus, the support member 230 and the spring 232 may reduce impacts generated when the lower die 210 makes contact with the upper die 220. As the lower die 210 is also upwardly moved, the lower die 210 and the upper die 220 compress the molding structure 280 and the substrate 260.

The heated molding structure 280 molds the bottom face of the substrate 260 using the pressure between the lower die 210 and the upper die 220. Particularly, the flat plate-shaped EMC 282 covers the chips or the solder balls of the substrate 290 to mold the substrate 290. As a result, a preliminarily molded substrate 300 including the substrate 290 and the molding structure is completed.

Referring to FIGS. 6, 8 and 12, after completing the compression of the substrate 290 and the molding structure 280, the lower die 210 is then moved downwardly from the upper die 220. Here, since the vacuum is still supplied to the preliminarily molded substrate 300 through the first vacuum holes 222 of the upper die 220, the preliminarily molded substrate 300 is attached to the upper die 220. Further, the preliminarily molded substrate 300 may be readily separated from the lower die 210 due to the release film 284 of the molding structure 280. The preliminarily molded substrate 300 is then separated from the upper die 220 by blocking the vacuum.

In step S240, the release film 284 of the separated preliminarily molded substrate 300 is then removed to form a molded substrate 310.

In this example embodiment, ultraviolet rays may be irradiated to the release film 284. Here, the ultraviolet rays may improve release properties of the release film 284 to readily separate the release film 284 from the preliminarily molded substrate 300. As a result, the molded substrate 310 including the substrate 290 and the flat plate-shaped EMC 282 may be completed.

Alternatively, the release film 284 may be partially removed until the flat plate-shaped EMC 282 is exposed to form the molded substrate 310 including the substrate 290 and the flat plate-shaped EMC 282. Here, the removal process may include an etching process, a grinding process, etc.

In this example embodiment, the substrate may be molded using the previously manufactured numerous molding structures. Thus, since EMC powder may not be used in the molding process, a process for measuring a weight of the EMC powder and a process for uniformly spreading the EMC powder may not be required. As a result, a time for molding process may be shortened so that productivity of the molding process may be improved. Further, the molding apparatus may not be contaminated or malfunction due to dust generated from the EMC powder.

Further, since the molding structure may include the release film, a process for providing the release film to the lower die may not be required. As a result, the molding process may become more simple and rapid.

According to the present invention, a molding structure, which is used for molding a substrate, may be previously formed before performing a molding process. Thus, since EMC powder may not be used in the molding process, a process for measuring a weight of the EMC powder and a process for uniformly spreading the EMC powder may not be required. As a result, a time for the molding process may be shortened so that productivity of the molding process may be improved. Further, a molding apparatus may not be contaminated or malfunction due to dust generated from the EMC powder.

Further, since the molding structure may include a release film, a process for: providing the release film to a lower die may not be required. As a result, the molding process may become more simple and rapid.

Having described the preferred embodiments of the present invention, it is noted that modifications and variations can be made by persons skilled in the art in light of the above teachings. It is therefore to be understood that changes may be made in the particular embodiment of the present invention disclosed which is within the scope and the spirit of the invention outlined by the appended claims.

What is claimed is:

1. A method of manufacturing a molding structure, comprising:
attaching a first release film on an upper face of a lower die;
applying epoxy molding compound (EMC) powder to the first release film;
attaching a second release film on a lower face of an upper die facing the lower die;
compressing the epoxy molding compound powder using the lower die and the upper die to form a flat plate-shaped epoxy molding compound; and
separating the lower die from the upper die with the first release film being attached to the flat plate-shaped epoxy molding compound to form a molding structure including the flat plate-shaped epoxy molding compound and the first release film.

2. The method of claim 1, wherein attaching the first release film, applying the epoxy molding compound powder, attaching the second release film, forming the flat plate-shaped epoxy molding compound and forming the molding structure are carried out at a room temperature.

3. The method of claim 1, wherein the second release film is held by the upper die using vacuum.

4. The method of claim 1, wherein the first release film has a thickness greater than that of the second release film.

5. The method of claim 1, wherein the second release film is repeatedly used.

6. The method of claim 1, further comprising forming an adhesive on an upper face of the first release film that makes contact with the epoxy molding compound powder.

7. A method of molding a substrate, comprising:
providing a molding structure, which includes a release film and a flat plate-shaped epoxy molding compound, on an upper face of a lower die;
holding the substrate with an upper die facing the lower die;
compressing the molding structure and the substrate using the lower die and the upper die to form a preliminarily molded substrate; and
removing the release film from the preliminarily molded substrate to form a molded substrate.

8. The method of claim 7, further comprising heating the molding structure on the lower die.

9. The method of claim 8, wherein the molding structure is heated to a temperature of about 150° C. to about 180° C.

10. The method of claim 7, wherein removing the release film from the preliminarily molded substrate comprises irradiating ultraviolet rays to the release film.

11. The method of claim 7, wherein the substrate is held by the upper die using vacuum.

12. The method of claim 7, wherein the substrate comprises a PCB having chips or a semiconductor substrate having solder balls.

13. An apparatus for molding a substrate, comprising:
a lower die for holding a molding structure that is used for molding the substrate;
an upper die arranged facing the lower die to hold the substrate;
a drive unit for moving the lower die upwardly and downwardly;
a storage unit for storing a plurality of molding structures; and
a transfer arm for transferring the molding structure in the storage unit to the lower die.

14. The apparatus of claim 13, wherein the upper die has vacuum holes vertically formed through the upper die to hold the substrate using vacuum supplied through the vacuum holes.

15. The apparatus of claim 13, wherein the storage unit comprises:
a case having an open upper face, the case having a space for receiving the molding structures and a passageway through which cold air circulates; and
a rotary plate passing through a bottom face of the case to support the stacked molding structures, the rotary plate upwardly moving the molding structures through the open upper face of the case by a rotation of the rotary plate.

16. The apparatus of claim 13, wherein the transfer arm has vacuum holes through which vacuum for holding the molding structure is supplied, and a heater for heating the molding structure on the lower die is built into the transfer arm.
